(19) United States
(12) Patent Application Publication
(10) Pub. No.: US 2026/0175712 A1
(43) Pub. Date: Jun. 25, 2026

(54) Suppression of Transient Overvoltages in an Electrical Energy Onboard System

(71) Applicant: Bayerische Motoren Werke Aktiengesellschaft, Muenchen (DE)

(72) Inventor: Florian BIERWIRTH, Steinhoering (DE)

(21) Appl. No.: 19/129,940

(22) PCT Filed: Oct. 26, 2023
(86) PCT No.: PCT/EP2023/079861

§ 371 Date: May 14, 2025

(30) Foreign Application Priority Data
Nov. 15, 2022 (DE) 10 2022 130 099.4

(51) Int. Cl. B60L 50/60; B60L 1/00; B60L 3/00; B60L 3/04; B60R 16/03

(52) U.S. Cl. CPC B60L 50/66; B60L 1/00; B60L 3/0069; B60L 3/04; B60R 16/03

(57) ABSTRACT

A vehicle with an electrical energy onboard system on which at least one load can be supplied with electric energy by a respective output stage circuit and can thus be operated. The output stage circuit has a supply input, the input voltage of which can be measured by a voltage measuring device, and the supply input is electrically connected to a load output via an electronic switch. The vehicle is designed to detect an overvoltage using the measurement data measured by the voltage measuring device and then close the electronic switch on the basis of the current vehicle operating state if the switch was previously open. Also disclosed is a method for suppressing transient overvoltages in an electrical energy onboard system of a vehicle. The present disclosure is particularly advantageously applicable to electric vehicles, in particular partially or fully automated electric vehicles.

### BACKGROUND AND SUMMARY

The present disclosure relates to a vehicle with an electrical energy onboard system, in which at least one load can be supplied with electrical energy via an electronic switch and thus be operated, wherein an input voltage can be measured using a voltage measuring device and the vehicle is configured to detect an overvoltage and then close the electronic switch. The present disclosure also relates to a method for suppressing transient overvoltages in an electrical energy onboard system of a vehicle, which comprises a power supply unit with a supply input and a load output, between which an electronic switch is arranged, wherein the load output is electrically connected to a load, and wherein the method includes measuring an input voltage at the supply input and then, if an overvoltage or impending overvoltage is detected based on the input voltage, the electronic switch is temporarily closed, provided that it was previously open. The present disclosure is particularly advantageously applicable to electric vehicles, especially to partially or fully autonomously operating electric vehicles.

Overvoltages in a vehicle's electrical energy onboard system can lead to component malfunctions and even damage, particularly at the semiconductor or battery level, and thus to the failure of highly available functions.

DE 197 42 391 C1 discloses a method for protecting electronic control units in a motor vehicle, in which overvoltage pulses, in particular load-dump pulses, are detected and one or more loads are activated when such overvoltage pulses occur. In this way, the overvoltage pulse can be reduced very quickly-even before it reaches its uncompensated peak value-so that the electronic circuits and control units contained in the vehicle are protected. This makes it possible to achieve overvoltage protection without the need for additional components. Furthermore, a device for implementing this method is provided.

DE 102 91 613 T5 discloses a system for eliminating overvoltage in a vehicle power supply, which includes: a load-absorbing device characterized by low resistance and high power consumption properties; and a control unit that selectively couples the load-absorbing device to the power supply system when a power supply voltage exceeds a predetermined threshold.

DE 10 2010 040 864 A1 discloses a method for operating an onboard electrical system of a vehicle, wherein the onboard system comprises a first subnetwork and a second subnetwork, and includes the following steps: redirecting an electric current from the first subnetwork into the second subnetwork upon detecting a voltage spike in the first subnetwork. A control device and a control program are also disclosed.

DE 10 2014 209 267 A1 discloses a heating device and a method for reducing an overvoltage in a first part of an onboard electrical system of an electrically driven vehicle. The method comprises the steps of: detecting the overvoltage or another signal indicating an impending overvoltage event in the first part of the onboard electrical system, and in response, closing an electrical connection between an electric heating device of the vehicle and the first part of the onboard electrical system to reduce the overvoltage.

An object of the present disclosure is to at least partially overcome the disadvantages of the prior art and in particular to provide an improved possibility for suppressing overvoltages in a vehicle's electrical energy onboard system.

This object is achieved in accordance with the features disclosed herein. Preferred embodiments are also set out in the present disclosure.

The object is achieved by a vehicle with an electrical energy onboard system, in which at least one load can be supplied with electrical energy and thus operated via a respective power supply unit (“output stage circuit”), wherein
the output stage circuit has a supply input, the input voltage of which can be measured by a voltage measuring device,
the supply input is electrically connected to a load output via an electronic switch, and
the vehicle is configured to detect an overvoltage based on the measurement data recorded by the voltage measuring device and then to close the electronic switch based on the current vehicle operating state, provided it was previously open.

This vehicle has the advantage that particularly many loads, including safety-critical ones, can be temporarily connected to the electrical energy onboard system to divert an overvoltage pulse, thereby being switched on or activated. This allows for especially effective suppression of the overvoltage pulse with minimal structural complexity. In doing so, the approach takes advantage of the fact that the selection of the load to be switched on and the corresponding type of switching can be adapted to the current vehicle operating state, so that, for example, safety-critical loads can also be temporarily switched on without triggering safety-critical reactions and/or violations of safety objectives.

The vehicle may, for example, be a vehicle with an internal combustion engine, a hybrid vehicle (e.g., a plug-in hybrid vehicle, PHEV), or a fully electric vehicle (e.g., a battery electric vehicle, BEV). The vehicle may in particular be a partially or fully autonomously driving vehicle, for which overvoltage suppression is particularly relevant for safety.

The electrical energy onboard system may have a single system voltage or may comprise two or more partial onboard systems with different system voltages, e.g., 12 V and 400 V.

The fact that a load can be supplied with electrical energy and thus operated via a respective output stage circuit means in particular that the load is supplied with electrical energy via the output stage circuit and is then switched on or activated, while the load is switched off or deactivated when the energy supply is interrupted by the output stage circuit. The load is therefore particularly “dumb” in the sense that it can be switched on and off via the associated output stage circuit and cannot switch itself on or off.

The output stage circuit receives the supply voltage for the load connected via the load output through the supply input, as the supply input is electrically connected to a load output via the electronic switch. The electronic switch may be a semiconductor switch, in particular a power semiconductor such as a transistor, in particular a MOSFET. If the electronic switch is in its non-conducting switching state (switch is “open”), the current path between the supply input and the load output is interrupted. If the electronic switch is in its conducting switching state (switch is “closed”), the current path between the supply input and the load output is electrically conductive.

The fact that the input voltage can be measured by a voltage measuring device may include that the voltage is measured regularly and that the measured voltage values are forwarded for further analysis. This further processing is particularly advantageous because it allows not only for the detection of reaching or exceeding a threshold indicative of an overvoltage but also for the evaluation of a voltage curve that can, for example, provide early warning of an impending overvoltage. The voltage measuring device may also be referred to as a “voltage sensor.” In a particularly simple implementation, the voltage measuring device is configured as an overvoltage sensor, which only emits or switches an output signal when the measured voltage reaches or exceeds a threshold indicative of an overvoltage. The overvoltage sensor may, for example, be a comparator or comprise one.

The fact that the vehicle—specifically at least one data processing unit of the vehicle—is configured to detect an (already occurring or potentially impending) overvoltage based on the measurement data recorded by the voltage measuring device particularly includes the evaluation of the measured voltage values or the detection of a change in the output signal of the overvoltage sensor.

Subsequently closing the electronic switch based on the current vehicle operating state, if it was previously open, particularly includes that the previously deactivated load is temporarily switched on depending on the current vehicle operating state to achieve overvoltage suppression. If the electronic switch is already closed, it remains closed, or the closed state is “forced.”

The vehicle operating state relevant for this includes, among other things, the onboard system condition resulting from the driving situation and occupant usage. Depending on the onboard system condition, certain loads must be excluded from overvoltage suppression via the output stage circuit or may be considered alternatively (e.g., steering while stationary vs. steering while driving). The vehicle operating state may include directly measured or preset vehicle information such as parameters and states, as well as information derived from them.

One embodiment provides that
the vehicle comprises a data processing unit (“status instance”) that is data-connected to a logic circuit of at least one output stage and communicates the current vehicle operating state to the logic circuit, and
the logic circuit is connected to the voltage measuring device and the electronic switch and is configured to detect an overvoltage based on the measurement data from the voltage measuring device and then either leave the electronic switch open or close it based on the current vehicle operating state.

This achieves the advantage that the output stage circuit can autonomously detect the overvoltage and independently actuate the electronic switch. This allows particularly fast switching. A further development provides that the logic circuit is configured—e.g., programmed—to translate the vehicle operating state into a corresponding or “suitable” actuation or switching of the electronic switch, for example with respect to the duration for which the electronic switch is closed.

A further development provides that upon detecting an overvoltage, the logic circuit retrieves the vehicle operating state from the status instance.

A further development provides that the logic circuit includes a rewritable data memory into which the current vehicle operating state can be transferred from the status instance. This has the advantage that the current vehicle operating state is already present in the output stage circuit, thereby allowing autonomous and particularly rapid switching of the electronic switch.

A further development provides that the status instance and the logic circuit are data-connected to one another via a data bus system. A further development provides that the status instance and the logic circuit are connected via at least one dedicated signal line.

A further development provides that the electronic switches of multiple output stage circuits can be actuated via an instance that is hierarchically superior to the output stage circuits. This provides the advantage that individual logic circuits in the output stage circuits can be omitted. Such a higher-level instance is particularly connected to the electronic switches via corresponding signal or control lines. It specifically comprises the function(s) of the output stage circuit.

One embodiment provides that the vehicle comprises a status instance that
maintains the current vehicle operating state, is connected to the electronic switch, and is data-connected to the voltage measuring device, and
is configured to detect an overvoltage based on the measurement data from the voltage measuring device and then either leave the electronic switch open or close it based on the current vehicle operating state.

This achieves the advantage that a separate logic circuit in the output stage circuit is not needed, and its above-described function is integrated into the status instance (which may then also be referred to as a “status and control instance”). Such a status instance therefore maintains the current vehicle operating state, monitors for the presence of an overvoltage, and is configured—e.g., programmed—to actuate the electronic switch based on the current vehicle operating state.

One embodiment provides that the vehicle includes at least one status instance that is connected to multiple output stage circuits, i.e., depending on the implementation, either to their logic circuits or directly to their electronic switches.

One embodiment provides that the vehicle operating state includes at least a vehicle speed, specifically the distinction between vehicle standstill and motion. This distinction offers the advantage that even safety-critical loads can be temporarily operated for overvoltage suppression while stationary, whereas they must not be used for overvoltage suppression during driving. For example, the actuation of an electric braking system is uncritical while stationary but not during driving. Additional possible conditions or information elements of the vehicle operating state can include, for example, seat occupancy, GPS coordinates, acceleration, on/off states—particularly of loads—equipment details, open or closed flaps, etc.

One embodiment provides that the vehicle operating state includes at least vehicle standstill, slow driving, and fast driving. This enables an even finer distinction when temporarily operating a currently inactive load for the purpose of overvoltage suppression. For example, an electric steering system may be operated briefly while the vehicle is stationary or moving slowly without presenting any safety-critical concerns or being noticed by vehicle occupants, but not while driving at high speeds. “Slow driving” may be understood, for instance, as driving at a speed of no more than 20 to 30 km/h, while “fast driving” would correspond to higher speeds. However, more than two speed levels may also be used. Furthermore, the speed threshold values may depend on the type of load involved.

One embodiment provides that the vehicle (e.g., the logic circuit or the status instance) is configured to actuate the open electronic switch based on the current vehicle operating state such that it
remains in its open switching state,
is closed for such a short time that the load does not perform a load action, or
is closed for such a duration that the load performs a load action, provided that this load action does not have a safety-relevant effect and is not noticed by a user of the vehicle.

This provides the advantage that overvoltages can be handled in a particularly effective and flexible manner without resulting in losses of safety or comfort. Leaving the open electronic switch in its open state means that the load is not used for overvoltage suppression but instead remains switched off. This may be the case, for example, if operating this particular load in the current driving state would result in a safety or comfort issue.

The fact that the open electronic switch is closed for such a short time that the load does not produce a load action includes the situation where the load is indeed switched on, but only for such a brief period that it consumes current—for example, to power up electronic components and/or circuitry—but does not perform its function, such as triggering a steering movement or creating braking force. Since overvoltages are very transient phenomena, short activation durations may be sufficient to limit them. A further development provides that the actuation of the electronic switch is also or alternatively dependent on whether the actuation would be noticed by a user.

The fact that the open electronic switch is closed for a duration long enough that the load performs a load action (e.g., steering movement or braking force), provided this action does not have a safety-relevant effect and is not noticed by a vehicle user, is particularly effective. For instance, even a safety-critical load such as an electric braking system or an electric steering system may be operated for a longer period while the vehicle is stationary, because performing a braking operation, for example, is neither safety-critical nor noticeable by the occupants in such a state.

One embodiment provides that the type of actuation is adjustable depending on the magnitude of the overvoltage. This results in the advantage that greater suppression can be provided for higher overvoltages, thereby allowing particularly flexible responses. For example, if an overvoltage is relatively small, it may be sufficient to forgo switching on certain loads or to activate them for shorter durations than would be the case for high overvoltage.

One embodiment provides that the output stage circuit includes a further or second voltage measuring device, which is configured to measure an output voltage present at the load output. This offers the advantage of redundancy and enables assessment of the switch status, e.g., for validating successful actuation of the electronic switch—even outside the context of overvoltage suppression, such as for a functionality check.

One embodiment provides that the electronic switch is a component of an electronic fuse (also referred to as an “e-fuse”) or is itself an electronic fuse.

One embodiment provides that the vehicle, in accordance with any of the preceding, comprises an output stage circuit integrated into a power distributor. This implementation is particularly cost-effective and compact—especially if the electronic switch is an e-fuse—because in such cases, an existing e-fuse already serving as a protection element can also be used as the electronic switch. The power distributor typically includes a supply input and multiple load outputs, which are particularly protected by e-fuses. A further development provides that the logic circuit, if present, is integrated into the power distributor. Another further development provides that the status instance is integrated into the power distributor.

The object is also achieved by a method for suppressing transient overvoltages in an electrical energy onboard system of a vehicle, which includes an output stage circuit with a supply input and a load output, between which an electronic switch is arranged, wherein the load output is electrically connected to a load, and wherein the method involves measuring an input voltage at the supply input and then, if an overvoltage or impending overvoltage is detected based on the input voltage, temporarily closing the electronic switch based on a current vehicle operating state, provided it was previously open. The method may be designed analogously to the vehicle described above-and vice versa-and provides the same advantages.

The above-described characteristics, features, and advantages of this present disclosure, as well as the manner in which they are achieved, become clearer and more readily understood in connection with the following schematic description of an embodiment, which is further explained with reference to the drawings.

### BRIEF DESCRIPTION OF THE DRAWING

FIG. 1 shows a diagram of a vehicle in accordance with various embodiments.

### DETAILED DESCRIPTION OF THE DRAWING

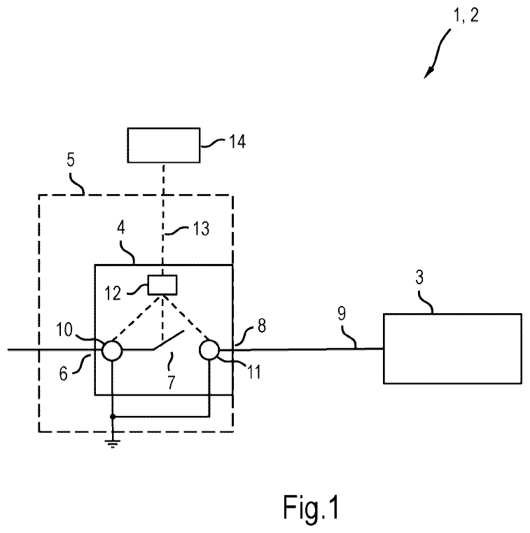

FIG. 1 shows a sketch of a vehicle 1 with an electrical energy onboard system 2, in which at least one load 3 can be supplied with electrical energy and thereby operated via a respective output stage circuit 4. The output stage circuit 4 may form part of a power distributor 5.

The output stage circuit 4 has a supply input 6, which is electrically connected to a load output 8 via an electronic switch in the form of an e-fuse 7. The load 3 is connected to the load output 8, e.g., via a power cable 9. An input voltage is present at the supply input 6, which nominally corresponds to the onboard system voltage but at which transient overvoltages may also occur. The input voltage can be measured by a first voltage measuring device 10. A second voltage measuring device 11 is connected between the e-fuse 7 and the load output 8, to measure the voltage at that point. If the e-fuse 7 is closed and thus in a conductive state, the load 3 is supplied with the onboard system voltage and is then switched on. If the e-fuse 7 is open and thus in a non-conductive state, the load 3 is disconnected from the onboard system voltage and is therefore switched off. Switching the e-fuse therefore switches the load 3 on or off.

The e-fuse 7 is connected via a control line to a logic circuit 12, which logic circuit 12 can send control signals to open or close the e-fuse 7 as desired. The logic circuit 12 is also connected to the first voltage measuring device 10 and the second voltage measuring device 11 via signal, in particular data lines, through which the measurement signals or data output by the voltage measuring devices 10, 11 can be transmitted to the logic circuit 12. The logic circuit 12 is also data-connected—e.g., via a data bus 13—to an instance external to the output stage circuit (a “status instance” 14), which keeps the logic circuit 12 informed about the current vehicle operating state. Alternatively, the function of the logic circuit 12 can be integrated into the status instance 14, so that a separate logic circuit 12 is no longer necessary.

If an overvoltage or impending overvoltage is detected at the supply input 6 via the voltage measuring device 10 or the logic circuit 12, the logic circuit 12 determines—depending on the current vehicle operating state—whether the currently open e-fuse 7 should remain open or be temporarily closed, and in particular, for how long it should remain closed in order to limit an overvoltage. Specifically, the duration of the conductive state of the e-fuse 7 may depend on the driving speed of the vehicle 1, e.g., whether it is stationary, moving slowly, or moving quickly. This can also depend on the magnitude of the overvoltage.

Naturally, the present disclosure is not limited to the embodiment shown.

Generally, the terms “a,” “an,” etc., may be understood as singular or plural, in particular in the sense of “at least one” or “one or more,” etc., unless explicitly excluded, e.g., by the expression “exactly one,” etc. Likewise, a numerical indication may include both the exact number specified and a standard tolerance range, unless explicitly excluded.

### LIST OF REFERENCE SIGNS

1 Vehicle
2 Electrical energy onboard system
3 Load or output stage
4 Output stage circuit
5 Power distributor
6 Supply input
7 E-fuse
8 Load output
9 Power cable
10 First voltage measuring device
11 Second voltage measuring device
12 Logic circuit
13 Data bus
14 Status instance

1-12. (canceled)

13. A vehicle comprising:
an electrical energy onboard system, in which at least one load can be supplied with electrical energy and thereby operated via a respective output stage circuit,
wherein the output stage circuit comprises a supply input, an input voltage of which is measured by a voltage measuring device,
wherein the supply input is electrically connected to a load output via an electronic switch, and
wherein the vehicle is configured to detect an overvoltage based on measurement data from the voltage measuring device and then to close the electronic switch based on a current vehicle operating state, provided the electronic switch was previously open.

14. The vehicle according to claim 13, comprising:
a status instance that is data-connected to a logic circuit of the output stage circuit and is configured to report the current vehicle operating state to the logic circuit,
wherein the logic circuit of the output stage circuit is connected to the voltage measuring device and the electronic switch, and is configured to detect an overvoltage based on the measurement data from the voltage measuring device and then either leave the electronic switch open or close it depending on the current vehicle operating state.

15. The vehicle according to claim 14, comprising:
at least one status instance that is connected to a plurality of output stage circuits.

16. The vehicle according to claim 14,
wherein the vehicle operating state includes at least standstill and driving of the vehicle.

17. The vehicle according to claim 16,
wherein the vehicle operating state includes at least standstill, slow driving, and fast driving of the vehicle.

18. The vehicle according to claim 14,
wherein the vehicle is configured to actuate the electronic switch that is open based on the current vehicle operating state such that it:
remains in its open switching state,
is closed for such a short time that the load does not perform a load action, or
is closed for such a duration that the load performs a load action, provided that the load action has no safety-relevant impact and is not noticed by a user of the vehicle.

19. The vehicle according to claim 18,
wherein a type of actuation is adjustable based on a magnitude of the overvoltage.

20. The vehicle according to claim 13, comprising:
a status instance that is connected to the electronic switch, and is data-connected to the voltage measuring device, and is configured to:
maintain the current vehicle operating state, and
detect an overvoltage based on the measurement data from the voltage measuring device and then either leave the electronic switch open or close it depending on the current vehicle operating state.

21. The vehicle according to claim 13,
wherein the output stage circuit comprises a further voltage measuring device that is configured to measure an output voltage present at the load output.

22. The vehicle according to claim 13,
wherein the electronic switch is a component of an electronic fuse or is an electronic fuse.

23. The vehicle according to claim 13,
wherein the output stage circuit is integrated into a power distributor.

24. A method for suppressing transient overvoltages in an electrical energy onboard system of a vehicle, wherein the vehicle includes an output stage circuit with a supply input and a load output, between which an electronic switch is arranged, wherein the load output is electrically connected to a load, the method comprising:
measuring an input voltage at the supply input; and
temporarily closing the electronic switch based on a current vehicle operating state, provided it was previously open, in response to an overvoltage or impending overvoltage being detected based on the input voltage.

25. The method according to claim 24, comprising:
reporting the current vehicle operating state by a status instance that is data-connected to a logic circuit of the output stage circuit and is configured to report the current vehicle operating state to the logic circuit;
detecting, by the logic circuit connected to the voltage measuring device and the electronic switch, an overvoltage based on measurement data from the voltage measuring device; and
leaving the electronic switch open or closing it depending on the current vehicle operating state.

26. The method according to claim 25,
wherein the vehicle operating state includes at least standstill and driving of the vehicle.

27. The method according to claim 26,
wherein the vehicle operating state includes at least standstill, slow driving, and fast driving of the vehicle.

28. The method according to claim 25, comprising:
actuating the electronic switch that is open based on the current vehicle operating state such that it:
remains in its open switching state,
is closed for such a short time that the load does not perform a load action, or
is closed for such a duration that the load performs a load action, provided that the load action has no safety-relevant impact and is not noticed by a user of the vehicle.

29. The method according to claim 28, comprising:
adjusting a type of actuation based on a magnitude of the overvoltage.

30. The method according to claim 24, comprising:
maintaining, by a status instance that is connected to the electronic switch, and is data-connected to the voltage measuring device, the current vehicle operating state;
detecting an overvoltage based on measurement data from the voltage measuring device; and
leaving the electronic switch open or closing it depending on the current vehicle operating state.

31. The method according to claim 24, comprising:
measuring, by a further voltage measuring device of the output stage circuit, an output voltage present at the load output.
